(19) United States
(12) Patent Application Publication
(10) Pub. No.: US 2025/0091063 A1
(43) Pub. Date: Mar. 20, 2025

(54) POWDER COATING GUN INCLUDING TRIGGER MECHANISM LOCKABLE WITH GRIP

(71) Applicant: Sistem Teknik Makina Sanayi Ve Ticaret Anonim Sirketi, Menderes, Izmir (TR)

(72) Inventor: Serdar KAYA, Menderes, Izmir (TR)

(21) Appl. No.: 18/566,407

(22) PCT Filed: Dec. 26, 2022
(86) PCT No.: PCT/TR2022/051607

§ 371 Date: Dec. 1, 2023

(51) Int. Cl. B05B 5/025; B05C 19/04

(52) U.S. Cl. CPC B05B 5/025; B05C 19/04

(57) ABSTRACT

The invention is related to a body (10) used for powder coating of workpieces, grip (20) that fits into the body (10) and allows manual gripping during the painting process, trigger element (31) to which the first pressure is applied for triggering, which is squeezed when the trigger element (31) is pressed, the coating gun (1) comprising an elastic element (32) which elongates when released, thereby allowing or blocking the passage of the coating material, a trigger mechanism (30) comprising a lock channel (33) for locking the grip (20) to the body (10), and an extractor (21) which engages the lock channel (33) and thereby allows the grip (20) to engage with the body (10).

### TECHNICAL FIELD

The invention relates to a coating gun for use in powder coating applications. In particular, the invention relates to an improvement in the trigger locking mechanism of a powder coating gun.

### PRIOR ART

Electrostatic powder coating is a solvent-free surface coating method. The coating material is very fine powder paint particles that form the topcoat paint layer. The powder paint is shot in the paint booth by means of special paint guns. Powder paint particles, which are electrostatically charged as they pass through the gun, adhere to the material to be painted in the cabin and the coating process is realized.

Powder coating application is carried out by means of an electrostatic gun. As the powder paint leaves the gun, it is electrostatically charged negatively by a high-voltage electrode at the tip of the gun. Since the part to be painted is grounded, the electrostatically charged paint easily adheres to the part.

In the coating guns used in the present art, the trigger is locked by a limiter applied to the outside of the gun, which is an extra-mounted part on the body. It was limited in this way because after the trigger was pressed, the trigger would move forward while returning to the inoperative position.

The present art also includes articulated triggers. These triggers are limited because they cannot make a linear movement back and forth (circular movement).

There are some applications in the national and foreign patent literature for a powder coating gun with a lockable trigger mechanism.

The application with the code TR201508591 in the national patent literature is related to powder coating injectors where the powder paint taken from the powder coating warehouse is delivered to the powder coating gun, and its feature is; the injector body formed in an angled structure that allows the powder coating to be sent stably without breaking, at least one passageway in the injector body that allows the powder coating to pass at an angle, at least one vacuum check valve and injector body that allows the powder coating to be sucked from the tank on the passageway, at least one auxiliary air check valve that allows the powder coating to be delivered to the powder coating gun on the angled passageway, at least one hose holder through which the powder coating sent through the auxiliary air check valve is delivered to the powder coating gun. The application coded CN204974254U in the Chinese patent literature relates to a coating gun, including the body and spare parts, and includes a locking nut on the body.

As a result, the existence of the above problems and the lack of an existing solution necessitated a development in the relevant technical field.

### PURPOSE OF INVENTION

The invention aims to solve the above-mentioned problems, eliminate all disadvantages and bring additional advantages to the structure.

The purpose of the invention is to provide the industry with a grip with a limiter on the receiver that switches to the unloading and a locking mechanism on the trigger channel that provides locking thanks to the unloading. The limiter limits the trigger, and the trigger fits into the gun thanks to the discharge. The trigger is used to control the function of the powder coating gun. When the trigger is pressed, the powder coating gun operates, when the trigger is released, it returns to its initial position and the electrostatic loading process of the powder coating gun stops.

A benefit of the invention is that the trigger is easy to remove and install. It can be disassembled and reassembled only when the grip is removed or when the locking is pulled down enough to disengage.

The invention is to fulfill the aforementioned purposes;

The invention relates to a coating gun for powder coating work pieces, comprising a body, a handle which engages with the body and allows a hand grip during the painting process; characterized by comprising;
a trigger element where the first pressure is applied for triggering, an elastic element that compresses when the trigger element is pressed, extends when released and thus allows the passage of the coating material or closes the passage, a trigger mechanism including a lock channel that allows the handle to be locked to the body,
the tab which engages in the lock groove and thereby enables the grip to engage with the body.

The structural and characteristic features, working principle and advantages of the invention will be more clearly understood by means of the figures given below and the detailed description written with references to these figures. Therefore, the evaluation should be made by taking these figures and detailed description into consideration.

### BRIEF DESCRIPTION OF THE FIGURES

FIG. 1. shows the trigger part of the coating gun in detail.

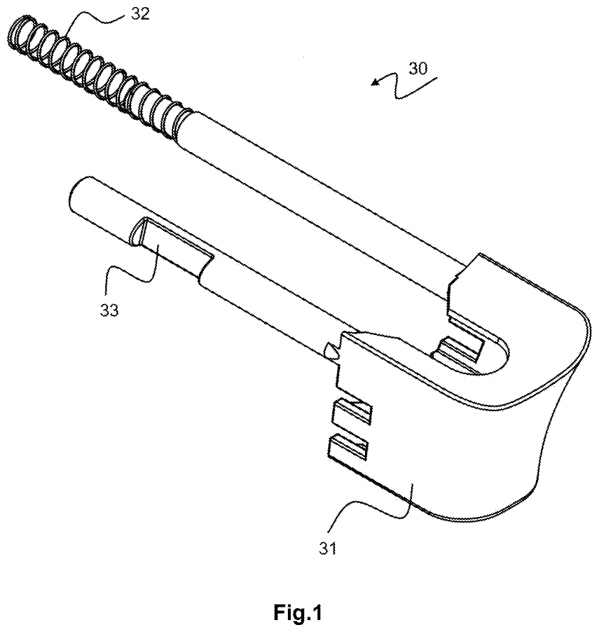

FIG. 2. shows the grip part of the coating gun in detail.

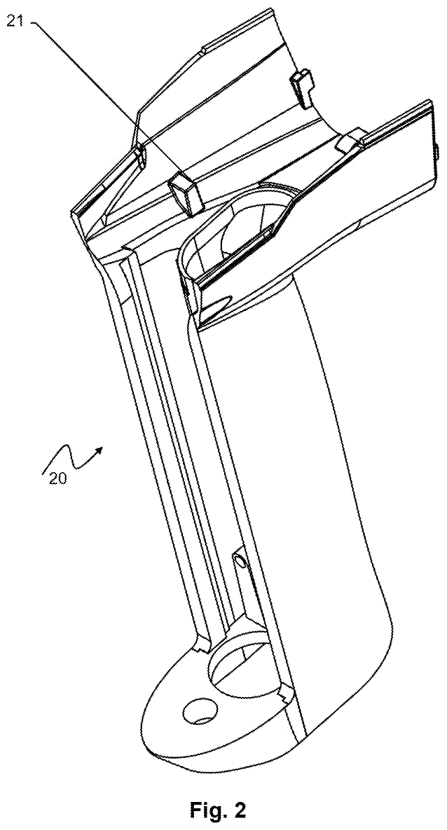

FIG. 3. shows the body part of the coating gun in detail.

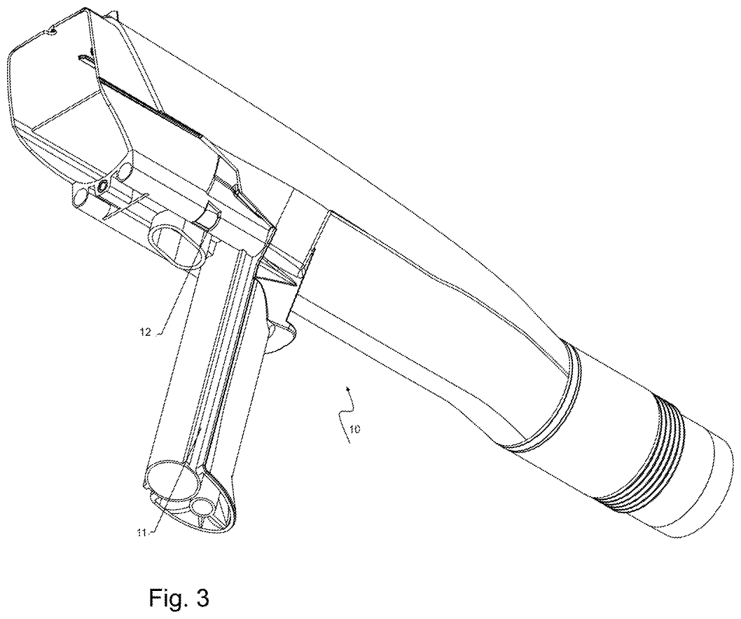

FIG. 4. shows the free and triggered state of the trigger part of the coating gun in detail.

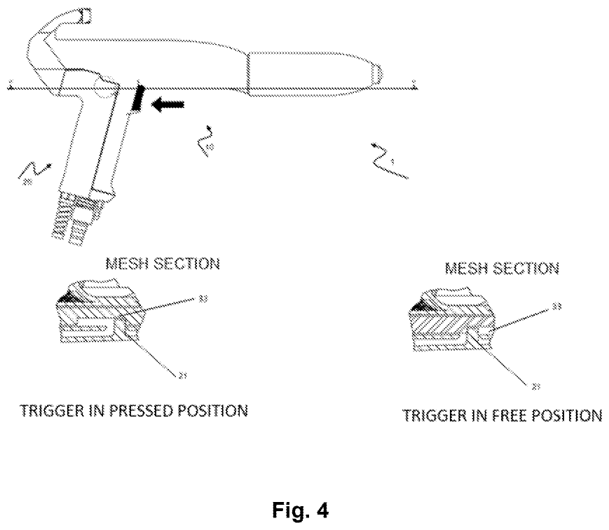

### REFERENCE NUMBERS

1. Coating gun
10. Body
11. Grip engagement channel
12. Extractor channel
20. Grip
21. Extractor
30. Trigger mechanism
31. Trigger element
32. Elastic element
33. Lock channel

### DETAILED DESCRIPTION OF THE INVENTION

The coating gun (1) is a structure used for powder coating of work pieces, which charges the coating material with electrostatic charge and ensures adhesion by spraying it to the grounded area. The coating gun (1), in its most general form, consists of a body (10), a grip (20) and a trigger mechanism (30).

The grip (20) is the part of the coating gun (1) which is gripped by the hand. It includes an extractor (21) which allows the grip (20) to engage with the body (10). The extractor (21) also limits the movement of the trigger.

The body (10) is the main structure carrying the grip (20) and the trigger mechanism (30). On the body (10), there is a grip engagement channel (11) that allows the grip (20) to be inserted into the body (10) and an extractor channel (12) for the extractor (21) in the grip (20).

The trigger mechanism (30) is the mechanism that causes the spraying of the coating material from the coating gun (1).

The trigger mechanism (30) consists of a trigger element (31), an elastic element (32) and a lock channel (33). The trigger element (31) is the structure where the initial pressure is applied for triggering. The elastic element (32) is the structure that compresses when the trigger element (31) is pressed and extends when released. The elastic element (32) is a spring. Lock channel (33) is a structure that enables the trigger mechanism (30) and the grip (20) to be locked. The extractor (21) on the grip (20) engages the lock channel (33).

1. A coating gun for powder coating work pieces, comprising a body, a grip which engages with said body and allows a hand grip during the painting process, further comprising:
a trigger mechanism comprising a trigger element to which a first pressure is applied for triggering, an elastic element which compresses when said trigger element is pressed and extends when released, thereby allowing or blocking the passage of the coating material, and a lock channel for locking said grip to said body; and
an extractor which engages said lock channel and thereby enables said grip to engage said body.

2. The coating gun according to claim 1, wherein said elastic element is a spring.

3. The coating gun according to claim 1, wherein said trigger element is positioned at the point where said grip joins said body and said positioning provides ergonomics by reducing the force on the wrist during application.
